(19) United States
(12) Patent Application Publication
(10) Pub. No.: US 2008/0207276 A1
(43) Pub. Date: Aug. 28, 2008

(54) Adjustable cell phone charger holder

(76) Inventor: David C. Burrell, (US)

Correspondence Address: David C. Burrell III, 17216 Harmon Pl, Upper Marlboro, MD, 20772, US

(21) Appl. No.: 11/710,671

(22) Filed: Feb. 26, 2007

(51) Int. Cl. H04M 1/00

(52) U.S. Cl. 455/573

(57) ABSTRACT

A adjustable cell phone charger holder that is fully functional and portable between vehicles. A hollow, fabricated flexible tubular-shaped body is oriented like a snake, with two openings one on each end. Attached to it's lower opening is a cell phone charger power adapter cord, in which the cell phone connector is removed and power adapter cord is pulled through the tubular body and the cell phone connector is reattached to the cord at the uppermost opening and pulled down into a slot at the top of the tube, a pivotal joint with a slot is inserted and is aligned so that the cell phone connector and cord are exposed. A small molded plastic cell phone holder is then attached to the top of pivotal joint. The flexible tubing can be placed in any vertical or parallel position, and the pivotal joint allows the cell phone holder to be tilted.

### RELATED APPLICATIONS

The present application is related to U.S. Pat. No. 6,081,695, issued Jun. 27, 2000, by Wallace, et al, included by reference herein.

The present application is related to U.S. Pat. No. 6,491,194, issued Dec. 10, 2002, by Marvin, included by reference herein.

The present application is related to U.S. Pat. No. D467,727, issued Dec. 31, 2002, by Kobayashi, included by reference herein.

The present application is related to U.S. Pat. No. D490,237, issued May 25, 2004, by Hardge, included by reference herein.

The present application is related to U.S. Pat. No. 6,742,685, issued Jun. 1, 2004, by Williams, included by reference herein.

The present application is related to U.S. Pat. No. 6,791,296, issued Sep. 14, 2004, by Chu, et al., included by reference herein.

The present application is related to U.S. Pat. No. 6,454,146, issued Sep. 24, 2004, by Alis, included by reference herein.

The present application is related to U.S. Pat. No. 6,888,940, issued May 3, 2005, by Deppen, included by reference herein.

The present application is related to U.S. Pat. No. 6,929,304, issued Aug. 16, 2005, by Alan, Dry, included by reference herein.

The present application is related to U.S. Pat. No. D521,725, issued May 30, 2006, by Clark, included by reference herein.

The present application is related to U.S. Pat. No. D524,042, issued Jul. 4, 2006, by Lavine, included by reference herein.

### FIELD OF THE INVENTION

The present invention relates to cell phones holders and chargers and, more particularly, to an adjustable holding device operative for securing, charing and holding such articles while using your hands free device and riding in your vehicle.

### BACKGROUND OF THE INVENTION

Cell phone holders and chargers are widely used in all motor vehicles. They are very popular among motor vehicle consumers because those consumers want a place to keep their phone secure and charged and in an easy to locate and accessible position. Many of these consumers use their cell phones continuously while in their vehicles some of them choose to place their cell phones in their lap, cup holders or passengers seat, some consumers choose to hold their cell phones in their hand while driving. In many cities and states there are hands free laws that have been enacted that would mandate a hands free system of using the cell phone while driving. This invention enables the user to comply with city and state laws for hands free use of cell phones, by permitting the user to charge the cell phone and adjust it to any vertical or parallel desired position that allows easy viewing of the phone display and use of their hands free device, it also prevents the said user from having to move or reach from the area in which they are seated. The present invention can also be utilized by rear seat passengers being driven in limousine or executive vehicles.

Initially, conventional cell phone holders were designed to hold cellular phones stationary on the passenger side of the vehicle in which the driver has to reach over to the passenger side to view or use the device. Certain inventors have developed more elaborate and complex mechanism for holding cell phones and charging them. Many of these cell phone holders and cell phone chargers can be found in many of your department and electronics stores, and mail order catalogs and are describe, for example, in U.S. Pat. No. 6,062,518 issued to Etue for CELLULAR PHONE RETAINER UTILIZING A CUP HOLDER.

Currently there are no devices that have been created to fulfill the need to securely hold a cell phone, charge it and have it setting at any position desired that is easily accessible and viewable by the user weather driving or riding in a vehicle. Current cell phone holders have to be set in one fixed position either clipped on a air vent or mounted to the interior console of the vehicle which causes the user to have to move forward and reach out for the device which can cause a distraction to the driver of the vehicle. Conventional cell phone holders are not moveable nor do they have the flexibility to be adjusted to any vertical or parallel position and furthermore it does not allow the user to freely remove the whole unit and use it in another vehicle. Moreover, no current approach addresses the problem of portability between vehicles, securing, charging and having the cell phone in a convenient and accessible position and location that allows the said user to utilize a hands free device.

It is therefore an object of the invention to provide a portable vehicle cell phone charger holder.

It is another object of the invention to provide a cell phone charger holder that can be adjusted to any vertical or parallel position that suites the users need.

It is another object of the invention to provide a adjustable cell phone charger holder that eliminates the hanging charger cord.

It is another object of the invention to provide a adjustable cell phone charger holder that will allow the use of the cell phone with the hands free device, is stationary, adjustable, removable and portable.

### SUMMARY OF THE INVENTION

In accordance with the present invention, there is provided a adjustable cell phone charger holder having a vehicle cell phone power adapter, fabricated flexiable tubing and a swivel cell phone holster. A vehicle cell phone power adapter is inserted through a fabricated flexible tubing, the cell phone connector is removed before inserting cord and then reattached on the uppermost point of tubing and pulled through small opening under pivotal joint. Attached to top of pivotal joint is cell phone swivel holster. The present invention provides a secure place for holding the phone and the ability to place the phone in any position that will require very little movement by the user during travel in a motor vehicle, thereby freeing the driver's hands for full control of the vehicle.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an adjustable cell phone charger holder showing all of it's main components;

FIG. 2 is a perspective view of an adjustable cell phone charger holder in use in vehicle;

FIG. 3 is a top exploded view of an of power adapter with silicone strips and three electrical contacts;

FIG. 4 is a perspective view of a fabricated flexible tubing; and

FIG. 5 is an exploded detail view of a pivot joint fastened between swivel holster and fabricated flexible tubing.

For purposes of clarity and brevity, like elements and components will bear the same designations and numbering throughout the Figures.

### DESCRIPTION OF THE PREFERRED EMBODIMENT

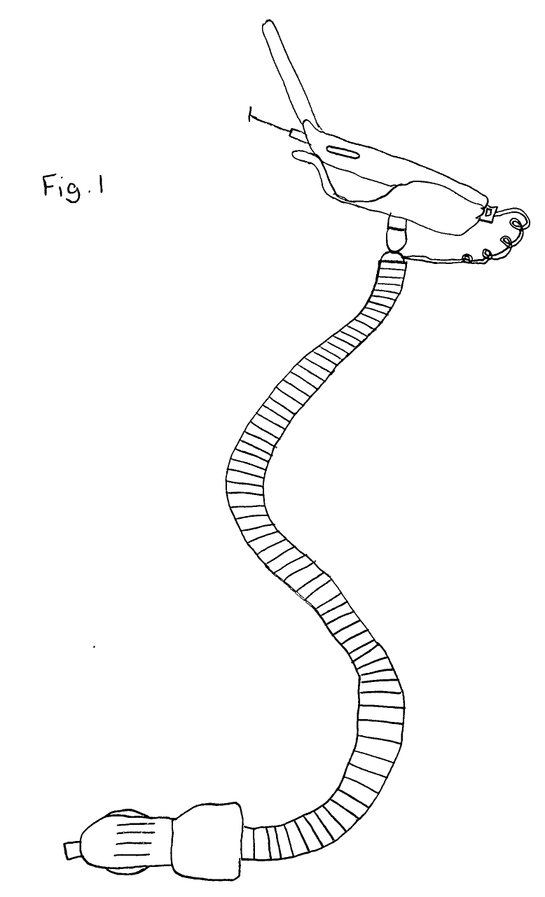

FIG. 1 is a perspective view of a adjustable cell phone charger holder, in accordance with the invention. A cell phone is depicted in swivel holster 18 which may be fabricated of plastic mold or any other suitable material.

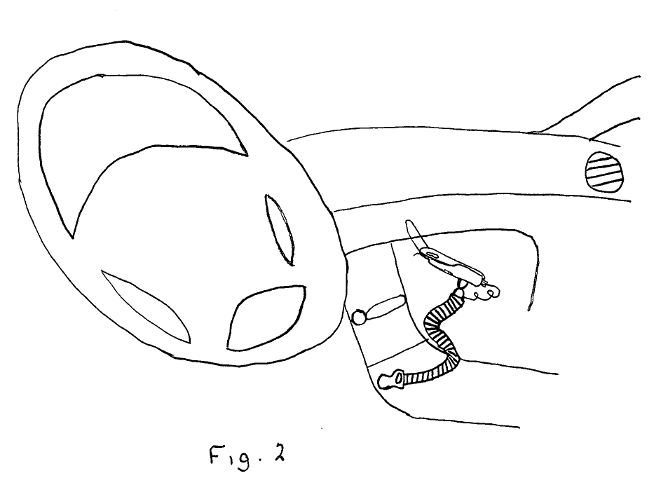

FIG. 2 depicts the adjustable cell phone charger holder in use in vehicle. This image illustrates one of many ways the adjustable cell phone charger holder can be used by driver and front seat passenger or rear seat passengers

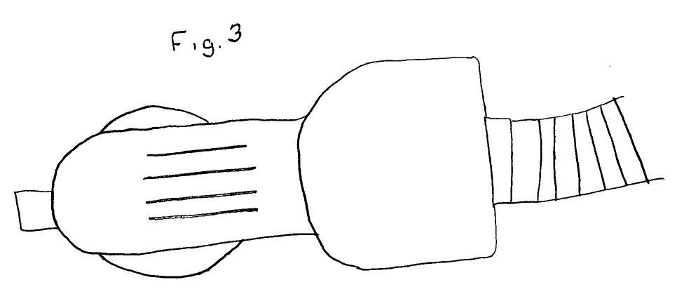

FIG. 3 depicts a top view of vehicle power adapter 10 with silicone strips 12 and electrical contacts 20. The power adapter 10 is a vehicle cigarette lighter connector comprising of a barrel, insertable into a vehicle cigarette lighter socket and having electrical terminals which make electrical contact with said socket upon insertion of said barrel into socket. The body of the power adapter 10 is comprised of a molded plastic shaped barrel with strips of rubber material attached to barrel of cigarette lighter insert for firm fitting.

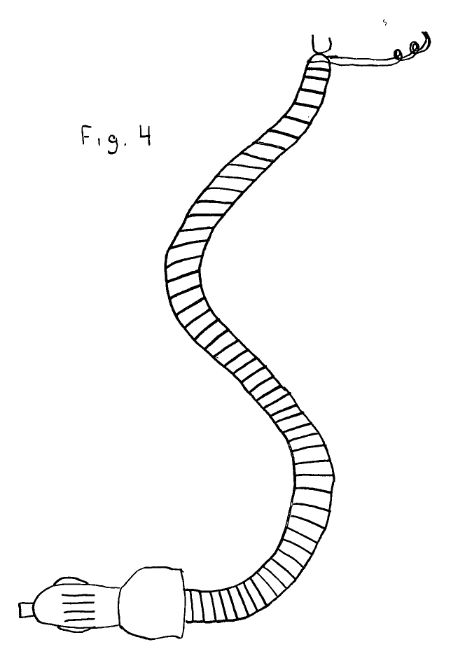

FIG. 4 depicts a side view of flexible tubing which may be fabricated of plastic, metal or aluminum. The flexible tubing can be maneuvered to obtain any vertical or parallel position desired. And the position will be maintained until user changes it.

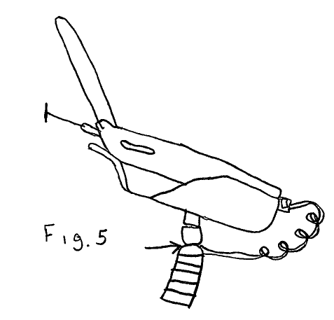

FIG. 5 depicts uppermost opening of fabricated flexible tubing 14 fastened to pivotal joint 16 and cell phone swivel holster 18. The pivotal joint 16 which can mechanically fastened to adapter of fabricated flexible tubing 14 and lower part of swivel holster 18 may be comprised of plastic or metal in a manner well known to those skilled in the art.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An adjustable cell phone charger holder for to hold your cell phone in any position that the users chooses while using their hands free device and charge the phone at the same time, comprising:
means for vertical and parallel positioning to suite the users need;
means for securing a snug fit into power adapter outlet and preventing movement;
means for allowing the cell phone to be tilted at different angles, rigidly connected to said means for vertical and parallel positioning to suite the users need;
means for turning the cell phone to different viewing angles, rigidly connected to said means for allowing the cell phone to be tilted at different angles;
means for making contact with cigarette lighter insert to receive electrical current for charging devices in your vehicle; and
means for charging the cell phone while it is secured in the swivel holster, rigidly connected to said means for securing a snug fit into power adapter outlet and preventing movement, and rigidly connected to said means for vertical and parallel positioning to suite the users need.

2. The adjustable cell phone charger holder in accordance with claim 1, wherein said means for vertical and parallel positioning to suite the users need comprises a new attribute 1 fabricated flexible tubing.

3. The adjustable cell phone charger holder in accordance with claim 1, wherein said means for securing a snug fit into power adapter outlet and preventing movement comprises a silicone strips.

4. The adjustable cell phone charger holder in accordance with claim 1, wherein said means for allowing the cell phone to be tilted at different angles comprises a new attribute 1 pivotal joint.

5. The adjustable cell phone charger holder in accordance with claim 1, wherein said means for turning the cell phone to different viewing angles comprises a swivel holster.

6. The adjustable cell phone charger holder in accordance with claim 1, wherein said means for making contact with cigarette lighter insert to receive electrical current for charging devices in your vehicle comprises a new attribute 1 electrical contacts.

7. The adjustable cell phone charger holder in accordance with claim 1, wherein said means for charging the cell phone while it is secured in the swivel holster comprises a new attribute 1 power adapter.

8. An adjustable cell phone charger holder for to hold your cell phone in any position that the users chooses while using their hands free device and charge the phone at the same time, comprising:
a new attribute 1 fabricated flexible tubing, for vertical and parallel positioning to suite the users need;
a silicone strips, for securing a snug fit into power adapter outlet and preventing movement;
a new attribute 1 pivotal joint, for allowing the cell phone to be tilted at different angles, rigidly connected to said fabricated flexible tubing;
a swivel holster, for turning the cell phone to different viewing angles, rigidly connected to said pivotal joint;
a new attribute 1 electrical contacts, for making contact with cigarette lighter insert to receive electrical current for charging devices in your vehicle; and
a new attribute 1 power adapter, for charging the cell phone while it is secured in the swivel holster, rigidly connected to said silicone strips, and rigidly connected to said fabricated flexible tubing.

9. An adjustable cell phone charger holder for to hold your cell phone in any position that the users chooses while using their hands free device and charge the phone at the same time, comprising:
a new attribute 1 fabricated flexible tubing, for vertical and parallel positioning to suite the users need;
a silicone strips, for securing a snug fit into power adapter outlet and preventing movement;
a new attribute 1 pivotal joint, for allowing the cell phone to be tilted at different angles, rigidly connected to said fabricated flexible tubing;
a swivel holster, for turning the cell phone to different viewing angles, rigidly connected to said pivotal joint;
a new attribute 1 electrical contacts, for making contact with cigarette lighter insert to receive electrical current for charging devices in your vehicle; and
a new attribute 1 power adapter, for charging the cell phone while it is secured in the swivel holster, rigidly connected to said silicone strips, and rigidly connected to said fabricated flexible tubing.
